(19) United States
(12) Patent Application Publication
(10) Pub. No.: US 2010/0235755 A1
(43) Pub. Date: Sep. 16, 2010

(54) DRIVER INTERFACE AND METHODS

(75) Inventors: Brian P. WILSON, Marion, NY (US); Joseph Dowling, Rochester, NY (US); Andrew Spooner, Webster, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/404,392

(22) Filed: Mar. 16, 2009

(51) Int. Cl. G06F 3/048

(52) U.S. Cl. 715/744

(57) ABSTRACT

Disclosed are methods of methods of propagating a customized user interface, and corresponding apparatus and computer-readable medium. The methods include displaying a user interface on a first computer, the user interface presenting options to a user to customize the user interface, receiving selections of the options to customize the user interface from the user, displaying the customized user interface to the user, presenting on the user interface an option to propagate the customized user interface to a second computer, receiving from the user a selection of the option to propagate the customized user interface to a second computer, and propagating the customized user interface to the second computer.

### BACKGROUND

Disclosed herein are methods for propagating a customized user interface, as well as corresponding apparatus and computer-readable medium.

Image forming devices such as printers, copiers, multi-function devices and digital imaging systems provide users the ability to print from a device such as a desktop or laptop computer, a handheld computer, or other electronic devices, to a printer connected to the device. The image forming devices may be stand alone devices, or may be connected in a network, such as in a business computing environment, which may include one or more printers, and the printer may be integrated into the image forming device.

A plurality of computers functioning as image forming devices or other electronic devices may be connected to one printer via a network. The image forming devices may include a user interface allowing a user to interface with the device. The user interface may be customizable. It would be advantageous if a customized user interface could be propagated to a plurality of the connected computers.

### SUMMARY

According to aspects of the embodiments, there is provided methods of propagating a customized user interface, and corresponding apparatus and computer-readable medium. The methods include displaying a user interface on a first computer, the user interface presenting options to a user to customize the user interface, receiving selections of the options to customize the user interface from the user, displaying the customized user interface to the user, presenting on the user interface an option to propagate the customized user interface to a second computer, receiving from the user a selection of the option to propagate the customized user interface to a second computer, and propagating the customized user interface to the second computer.

### BRIEF DESCRIPTION OF THE DRAWINGS

FIG. 1 illustrates a block diagram of a system.

FIG. 2 illustrates a block diagram of a system.

FIG. 3 illustrates a diagram of a user interface.

FIG. 4 illustrates a diagram of a user interface.

FIG. 5 illustrates a diagram of a user interface.

FIG. 6 illustrates a diagram of a printer driver user interface.

FIG. 7 illustrates a flowchart of a method.

### DETAILED DESCRIPTION

Aspects of the embodiments disclosed herein include methods of propagating a customized user interface. The methods includes displaying a user interface on a first computer, the user interface presenting options to a user to customize the user interface, receiving selections of the options to customize the user interface from the user, displaying the customized user interface to the user, presenting on the user interface an option to propagate the customized user interface to a second computer, receiving from the user a selection of the option to propagate the customized user interface to a second computer, and propagating the customized user interface to the second computer.

Aspects of the embodiments also include an apparatus for propagating a customized user interface from a first computer to a second computer. The apparatus may include a memory that stores instructions, and a processor that executes the instructions to cause propagation of the customized user interface by: displaying a user interface on the first computer, the user interface presenting options to a user to customize the user interface; receiving selections of the options to customize the user interface from the user; displaying the customized user interface to the user; presenting on the user interface an option to propagate the customized user interface to the second computer; receiving from the user a selection of the option to propagate the customized user interface to the second computer; and propagating the customized user interface to the second computer.

The embodiments further include a computer-readable medium that includes a computer-usable data carrier storing instructions, the instructions when executed by a first computer causing the first computer to propagate a customized user interface from the first computer to a second computer by: displaying a user interface on the first computer, the user interface presenting options to a user to customize the user interface; receiving selections of the options to customize the user interface from the user; displaying the customized user interface to the user; presenting on the user interface an option to propagate the customized user interface to the second computer; receiving from the user a selection of the option to propagate the customized user interface to the second computer; and propagating the customized user interface to the second computer.

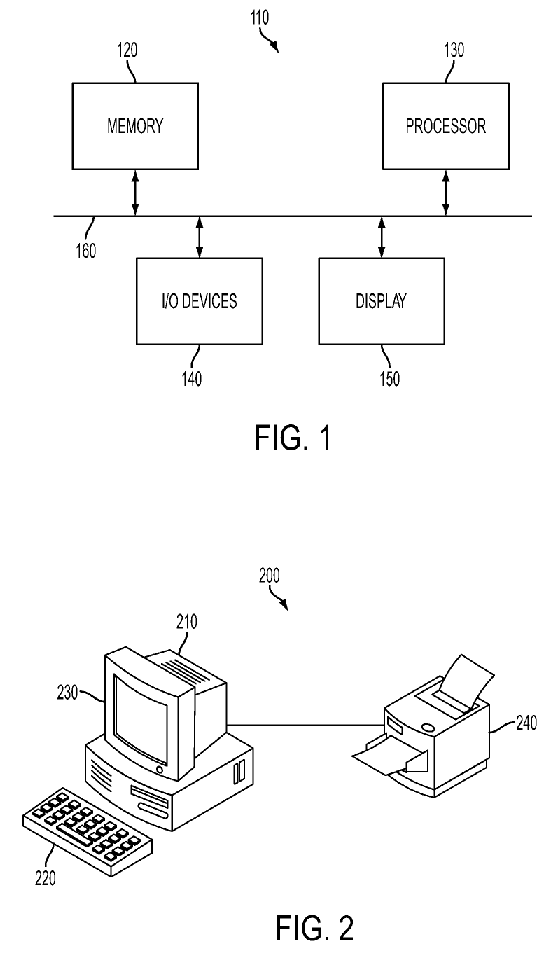

FIG. 1 illustrates a diagram of a system 110. The system 110 may be embodied within devices such as a desktop computer, a laptop computer, a handheld computer, a handheld communication device, or another type of computing device, or the like. The system 110 may include a memory 120, a processor 130, input/output devices 140, a display 150 and a bus 160. The bus 160 may permit communication and transfer of signals among the components of the computing device 110.

Processor 130 may include at least one conventional processor or microprocessor that interprets and executes instructions. The processor 130 may be a general purpose processor or a special purpose integrated circuit, such as an ASIC, and may include more than one processor section. Additionally, the system 110 may include a plurality of processors 130.

Memory 120 may be a random access memory (RAM or another type of dynamic storage device that stores information and instructions for execution by processor 130. Memory 120 may also include a read-only memory (ROM which may include a conventional ROM device or another type of static storage device that stores static information and instructions for processor 130. The memory 120 may be any memory device that stores data for use by system 110.

Input/output devices 140 (I/O devices) may include one or more conventional input mechanisms that permit a user to input information to the system 110, such as a microphone, touchpad, keypad, keyboard, mouse, pen, stylus, voice recognition device, buttons, etc., and output mechanisms such as one or more conventional mechanisms that output information to the user, including a display, one or more speakers, a storage medium, such as a memory, magnetic or optical disk, disk drive, a printer device, etc., and/or interfaces for the above. The display 150 may typically be an LCD or CRT display as used on many conventional computing devices, or any other type of display device.

The system 110 may perform functions in response to processor 130 by executing sequences of instructions or instruction sets contained in a computer-readable medium, such as, for example, memory 120. Such instructions may be read into memory 120 from another computer-readable medium, such as a storage device, or from a separate device via a communication interface, or may be downloaded from an external source such as the Internet. The system 100 may be a stand-alone system, such as a personal computer, or may be connected to a network such as an intranet, the Internet, or the like.

The memory 120 may store instructions that may be executed by the processor to perform various functions. For example, the memory may store instructions to allow the system to perform various user interface functions.

FIG. 2 illustrates a system 200. The system 200 includes a computer 210, which includes the elements of system 110, including the memory 120, the processor 130, I/O devices 140 and a display 150. The computer 210 could be a standard personal computer, or could be another type of computing device such as a digital imaging system, a handheld computer, a phone, a laptop computer, or the like.

The system 200 may also include a keyboard 220 functioning as an input device. The keyboard may be replaced or supplemented by the input devices as illustrated in FIG. 1.

The system 200 may also include a display 230 functioning as an output device for displaying images generated or received by the computer 210, corresponding to display 150 shown in FIG. 1. The display 230 may display images to be viewed by a user, such as various application programs, a user interface (UI), text, photographic images, or the like. For example, the display may generate various user interfaces in response to instructions stored in memory 120, such as a user interface for a digital imaging system.

The system 200 may have a printer 240 connected thereto for printing data such as images, text, or the like in response to a user directing the computer 210 to print, for example. In response to such a print command, the processor will typically cause the print driver to communicate with the printer to perform the needed printing. The printer 240 may be a small printer, or may be a large printer or electronic device such as used in a digital production system such as a digital press, or the like. The computer 210 may be an integral part of a printing device, such as a digital production system, and may include a digital front end including software providing user interfaces and the like for assisting a user in operating the system.

The system 200 may be connected to a network, such as such as an intranet, the Internet, a wireless network, or the like. In addition, the system 200 may be connected to a plurality of printers such as printer 240. The plurality of printers may be of a same printer type or of varying printer types. Further, the system 200 and the printer 240 may be integrated into one unit.

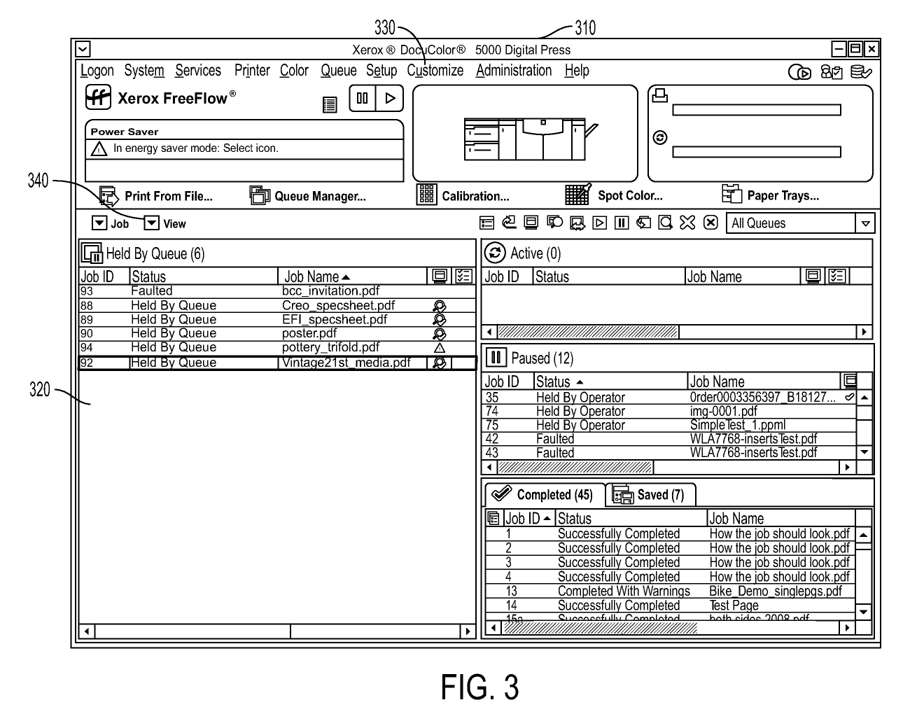

FIG. 3 illustrates a user interface 310 that may be displayed on a display of computer 210. The user interface 310 may be invoked and displayed when a user selects a function on the computer 210, typically using an input device such as keyboard 220, for example. The user interface 310 may include various display areas 320. The display areas may display various items, such as a list of documents available to be worked on, the status of the jobs, and the like, for example. In FIG. 3, the display areas include a display area showing jobs Held by Queue, a display area showing Paused jobs, a display area showing Completed jobs, and a blank display area. Any type of display areas may be used.

The user interface 310 may also include various ways of adjusting the user interface 310, such as a view adjustment 340. The view adjustment 340 may allow a user to change the way the display areas 320 are displayed. For example, the display areas 320 in FIG. 3 cover approximately one half of the width of the user interface 310. The view adjustment may allow the user to change the way the display areas are displayed so that they instead are displayed with a different width, such as one third the width of the user interface, equal to the width of the user interface, or any other width. In a similar manner, the view adjustment could allow a user to change other aspects of the display area 320, such as a height of the display area, and the like. The view adjustment 340 may provide a drop down menu presenting user choices, or could open a separate window or interface presenting choices for selection to the user.

Other aspects of the display areas 320 could also be adjusted by a user. For example, a user could change a color of all or a part of a display area 320, could change a font or text size to be displayed in the display areas 320, or could change which headings are displayed in the display areas 320. Any number of other adjustments could be made.

The user interface 310 may also include a customize feature 330. The customize feature 330 may allow a user to customize the user interface 310 by activating the customize feature 330. For example, the customize feature 330 may include a drop down menu allowing the user choices for customizing the user interface 310, although methods other than a drop down menu would be equally applicable with embodiments.

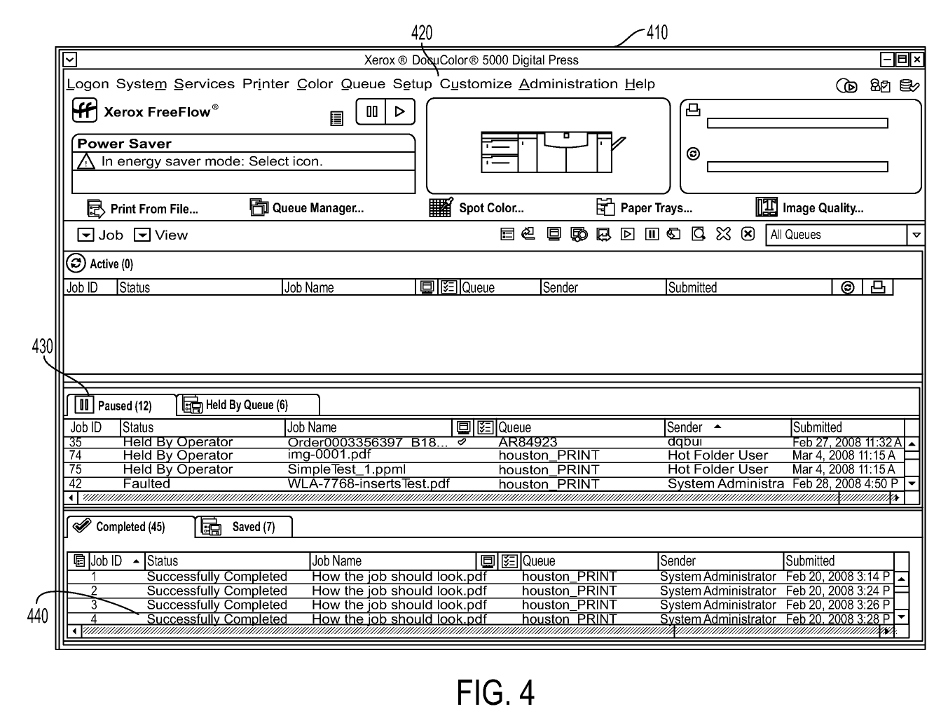

FIG. 4 illustrates an exemplary diagram of a further user interface 410 that may be displayed on a display of computer 210, for example. The user interface 410 includes a customize feature 420, which functions in a manner as described with the customize feature 330. The user interface 410 includes display areas, such as display areas 430 and 440. The user interface 410 has been customized by a user using either the view adjustment 340 or the customize feature 420, as compared to the user interface 310, so that display areas 430 and 440 are displayed with a width equal to a width of the user interface 410. Any other such customizations could also be made.

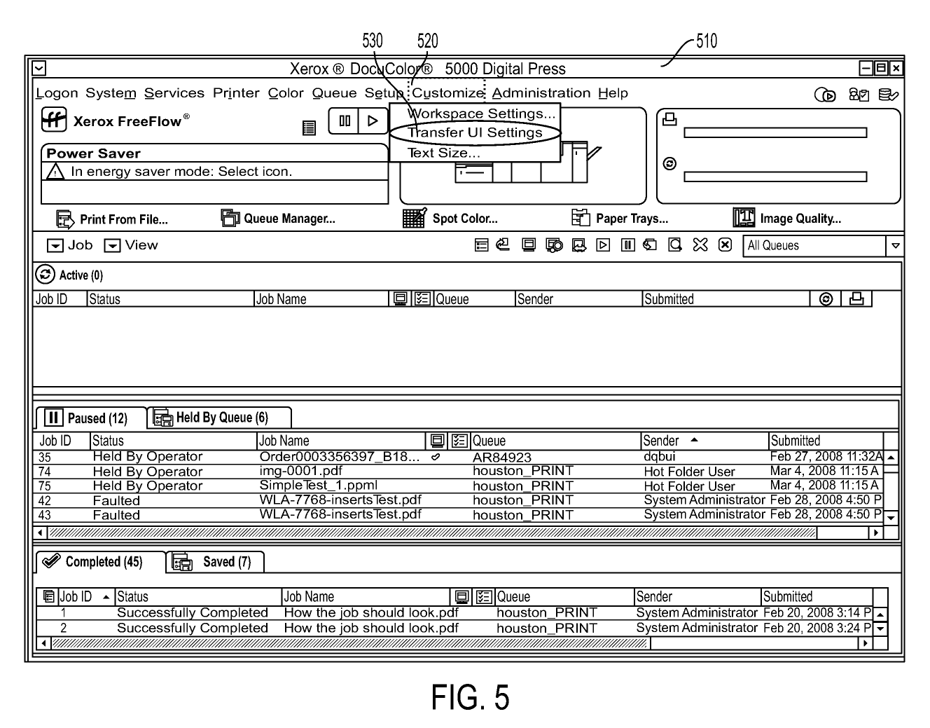

FIG. 5 illustrates an exemplary diagram of a further user interface 510 that may be displayed on a display of computer 210, for example. The user interface 510 includes the same features as the user interface 410, and shows the display areas customized to a width equal to width of the user interface 510. Additionally, the user interface 510 is illustrated with the customize feature 520 selected, and includes a Transfer UI settings selection 530 that is selectable by a user. In this example, one of the choices presented to the user is a Transfer UI Settings 530. The Transfer UI Settings 530 allows the user to transfer the user interface settings that have been customized to another computer.

This allows the user to quickly and efficiently propagate interface changes to one or more other computers. This is especially useful where multiple computers may be used by one or more users and it would be advantageous to propagate changes to the interface to other computers. For example, a digital press may be accessed by a plurality of computers, and it may be advantageous to propagate changes to the user interface of one of the computers to other computers. This may be useful where a user makes a plurality of changes to the user interface and wants to quickly set up user interfaces on other computers to have the same changes, without having to manually make the changes on each computer.

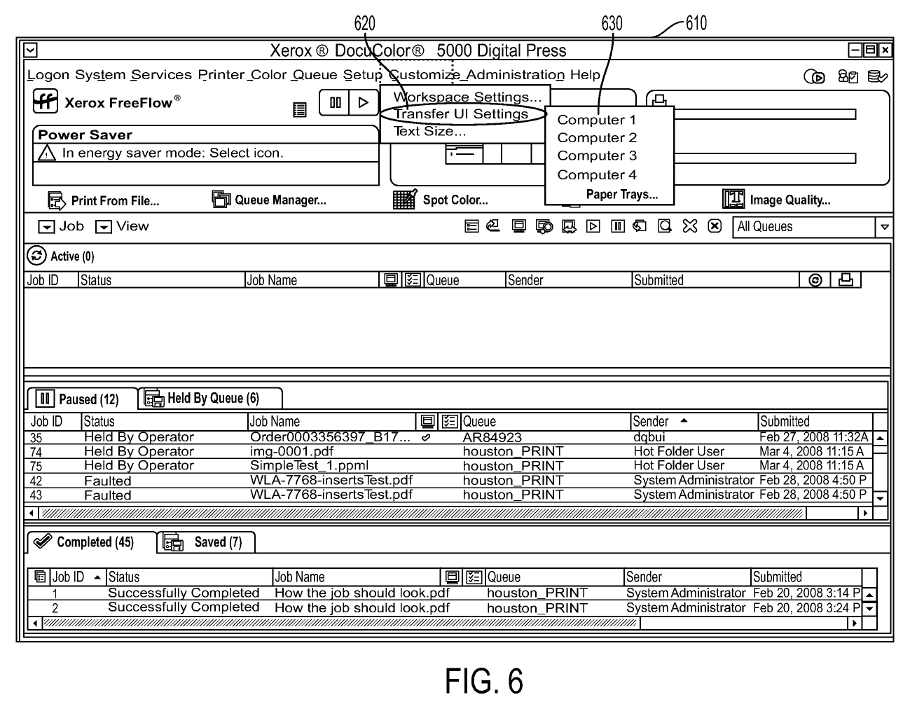

FIG. 6 illustrates an exemplary diagram of a further user interface 610 that may be displayed on a display of computer 210, for example. The user interface 610 includes the same features as the user interfaces 410 and 510, and shows the display areas customized to a width equal to width of the user interface 610. Any number or type of features may be customized onto the user interfaces 410, 510 and 610. In the user interface 610, the user may select the Transfer UI Setting 620 through the use of a drop down box or the like. Selection of the Transfer UI Settings 620 may cause presentation on the user interface 610 of a list of computers or other electronic devices 630 that may be selected from by the user to transfer the user interface settings to.

The list of computers or other electronic devices 630 for transfer of the UI Settings may be presented with a drop down list or by any other method, allowing the user to select one or more computers to transfer the UI Settings to. The list of computers or other electronic devices 630 for transfer of the UI Settings may be preset by a user, an administrator, a manufacturer or the like. The list of computers or other electronic devices 630 for transfer of the UI Settings may for example include computers connected together in a network. For example, in the case of a digital press connected to a plurality of computers over an intranet or other network, the list may include all computers connected to the digital press in the network.

When the user selects one or more computers to transfer the UI Settings to, the UI Settings are transferred to the other selected computers over the network. The network may be any type of network, such as an intranet, a wireless network, the Internet, or the like. The UI Settings are then incorporated into the user interface of the one or more computers selected by the user. In this way, if the user or others are using the other computers, the UI Settings do not have to be manually changed on each computer.

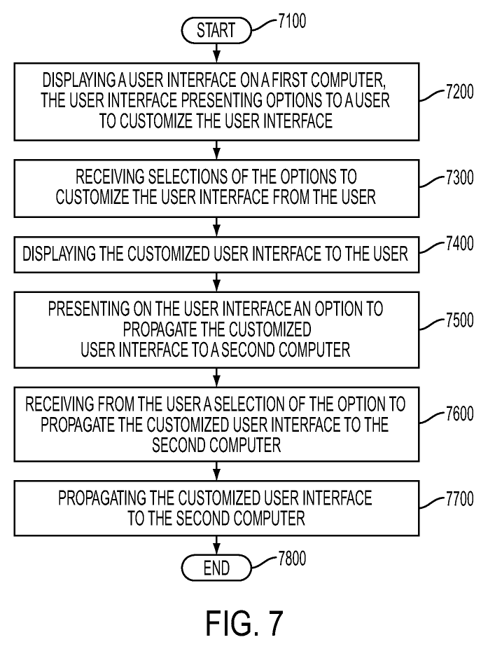

FIG. 7 illustrates a flowchart of a method of propagating a customized user interface. The method starts at 7100. At 7200, a user interface is displayed on a first computer. The user interface presents options to a user to customize the user interface.

At 7300, selections of the options to customize the user interface are received from the user. At 7400, the customized user interface is displayed to the user.

At 7500, an option to propagate the customized user interface to a second computer is displayed to the user on the user interface. At 7600, a selection of the option to propagate the customized user interface to the second computer is received from the user.

At 7600, the customized user interface is propagated to the second computer. At 7800, the method ends.

Embodiments as disclosed herein may also include computer-readable media for carrying or having computer-executable instructions or data structures stored thereon, such as instructions to carry out methods disclosed herein. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of propagating a customized user interface, comprising:
displaying a user interface on a first computer, the user interface presenting options to a user to customize the user interface;
receiving selections of the options to customize the user interface from the user;
displaying the customized user interface to the user;
presenting on the user interface an option to propagate the customized user interface to a second computer;
receiving from the user a selection of the option to propagate the customized user interface to a second computer; and
propagating the customized user interface to the second computer.

2. The method of claim 1, further comprising implementing the customized user interface on the second computer.

3. The method of claim 1, further comprising presenting on the user interface an option to propagate the customized user interface to a plurality of computers.

4. The method of claim 3, further comprising:
receiving from the user a selection of a plurality of computers to propagate the customized user interface to; and
propagating the customized user interface to the selected plurality of the computers.

5. The method of claim 4, further comprising implementing the customized user interface on the selected plurality of computers.

6. The method of claim 1, wherein the first computer comprises a digital imaging system.

7. The method according to claim 6, wherein the digital imaging system comprises a digital press.

8. An apparatus for propagating a customized user interface from a first computer to a second computer, comprising:
a memory that stores instructions; and
a processor that executes the instructions to cause propagation of the customized user interface by:
displaying a user interface on the first computer, the user interface presenting options to a user to customize the user interface;
receiving selections of the options to customize the user interface from the user;
displaying the customized user interface to the user;
presenting on the user interface an option to propagate the customized user interface to the second computer;
receiving from the user a selection of the option to propagate the customized user interface to the second computer; and
propagating the customized user interface to the second computer.

9. The apparatus of claim 8, wherein the processor further causes propagation of the customized user interface by implementing the customized user interface on the second computer.

10. The apparatus of claim 8, wherein the processor further causes propagation of the customized user interface by presenting on the user interface an option to propagate the customized user interface to a plurality of computers.

11. The apparatus of claim 10, wherein the processor further causes propagation of the customized user interface by:
receiving from the user a selection of the plurality of computers to propagate the customized user interface to; and
propagating the customized user interface to the selected plurality of the computers.

12. The apparatus of claim 11, wherein the processor further causes propagation of the customized user interface by implementing the customized user interface on the selected plurality of computers.

13. The apparatus of claim 8, wherein the first computer comprises a digital imaging system.

14. The apparatus of claim 8, wherein the digital imaging system comprises a digital press.

15. A computer-readable medium, comprising:
a computer-usable data carrier storing instructions, the instructions when executed by a first computer causing the first computer to propagate a customized user interface from the first computer to a second computer by:
displaying a user interface on the first computer, the user interface presenting options to a user to customize the user interface;
receiving selections of the options to customize the user interface from the user;
displaying the customized user interface to the user;
presenting on the user interface an option to propagate the customized user interface to the second computer;
receiving from the user a selection of the option to propagate the customized user interface to the second computer; and
propagating the customized user interface to the second computer.

16. The computer-readable medium of claim 15, wherein the instructions further comprise instructions causing the computer to further cause propagation of the customized user interface by implementing the customized user interface on the second computer.

17. The computer-readable medium of claim 15, wherein the instructions further comprise instructions causing the computer to further cause propagation of the customized user interface by presenting on the user interface an option to propagate the customized user interface to a plurality of computers.

18. The computer-readable medium of claim 17, wherein the instructions further comprise instructions causing the computer to further cause propagation of the customized user interface by:
receiving from the user a selection of the plurality of computers to propagate the customized user interface to; and
propagating the customized user interface to the selected plurality of the computers.

19. The computer-readable medium of claim 17, wherein the instructions further comprise instructions causing the computer to further cause propagation of the customized user interface by implementing the customized user interface on the selected plurality of computers.

20. The computer-readable medium of claim 17, wherein the first computer comprises a digital press.
